(19) United States
(12) Patent Application Publication
(10) Pub. No.: US 2022/0371522 A1
(43) Pub. Date: Nov. 24, 2022

(54) CONTAINER SECURING DEVICE

(71) Applicant: No Sacrifice Bags Inc., King (CA)

(72) Inventor: Donna L.E. Lehtonen, King (CA)

(21) Appl. No.: 17/663,914

(22) Filed: May 18, 2022

Related U.S. Application Data
(60) Provisional application No. 63/189,920, filed on May 18, 2021.

(51) Int. Cl. B60R 7/04; B60R 11/00; A45C 13/30

(52) U.S. Cl. CPC B60R 7/043; B60R 11/00; A45C 13/30; B60R 2011/0071; B60R 2011/0059; A45C 2013/306

(57) ABSTRACT

A container securing device having upper straps that attach to headrest posts on a rear portion of a seat in a vehicle connected to a lower securing strap by a mechanical junction ring, the lower securing strap having a plurality of hook-and-loop fastening points to form a loop to adjustably fit around a handle of any size of hand bag or carrying case.

### TECHNICAL FIELD

Embodiments of the technology relate, in general, to container securing technology, and in particular to devices for securing containers, such as purses, bags, carrying cases.

### BACKGROUND

Purses, handbags, and carrying cases are a convenient and preferred method for people to carry and transport personal items. When driving, people often keep their handbags and carrying cases on the passenger seat next to them. If the bag is open and the driver makes a quick stop, the bag may tip over and/or slide off the seat, thereby causing the contents of the bag to be spilled.

Another problem is the possibility of handbags and carrying cases being stolen from vehicles. Thieves find handbags and similar items sitting on car seats to be easy targets by reaching into open windows and snatching them from the seat. This occurs in parking lots, stop lights, and at gas stations where thieves will sneak up to a vehicle at a gas pump, open a passenger side door and take a handbag from the seat while the owner is distracted pumping gas.

Additionally, when traveling, it is often difficult and burdensome to securely carry a personal item (e.g., purse or briefcase) in addition to carry-on luggage as such items do not easily and securely attach to the luggage.

Conventional devices may attempt to address some of these issues, but many lack the necessary stability, are cumbersome and require removal to accommodate passengers, and/or put undue stress on bag handles.

Therefore, a need exists for a device that will secure a handbag or carrying case to secure it while driving or traveling and address the above-described issues.

### SUMMARY

In an embodiment, a securing device prevents containers, such as a purse or carrying case, from tipping over or falling on the floorboard of a vehicle while driving and enable a handbag and personal item to be securely attached to luggage when traveling.

### BRIEF DESCRIPTION OF THE DRAWINGS

The present disclosure will be more readily understood from a detailed description of some example embodiments taken in conjunction with the following figures.

FIG. 1 is a perspective view of a securing device according to an embodiment attached to a vehicle seat and a hand bag.

FIG. 2 is a front view of the securing device of FIG. 1.

FIG. 3 is a front view of the securing device of FIG. 1 in an open loop, non-use mode.

FIG. 4 is a side view of the securing device of FIG. 1 in a closed loop, use mode.

FIG. 5 is a rear view of the securing device of FIG. 1 securing a handbag and personal item to luggage.

FIG. 6 is a side view of the securing device of FIG. 1 securing a handbag and personal item to luggage.

FIG. 7 is a perspective view of the securing device of FIG. 1 including an extension strap.

FIG. 8 is a front view of an extension strap according to an embodiment.

FIG. 9 is a top view of a securing device according to an embodiment.

FIG. 10 is a perspective view of the securing device of FIG. 9 in use.

FIG. 11 is a perspective view of the securing device of FIG. 9 in use.

FIG. 12 is a perspective view of a securing device according to an embodiment shown securing a cargo container to a car seat.

FIG. 13 is a perspective view of a securing device according to an embodiment shown securing a modular cargo container to a car seat.

FIG. 14 is a perspective view of a compartment according to an embodiment.

FIG. 15 is a perspective view of an insulated container according to an embodiment.

FIG. 16 is a perspective view of an insulated container according to an embodiment.

FIG. 17 is a perspective view of an example container.

FIG. 18 is a perspective view of a securing device according to an embodiment including a drink caddy.

FIG. 19 is a side view of the securing device of FIG. 18.

FIG. 20 is a top view of the drink caddy of FIG. 18.

FIG. 21 is a perspective view of a securing device according to an embodiment including a food caddy.

FIG. 22 is a side view of a securing device according to an embodiment including a caddy.

FIG. 23 is a perspective view of a securing device according to an embodiment including a caddy.

FIG. 24 is a front view of a securing device according to an embodiment including a caddy.

FIG. 25 is a perspective view of an arresting strap coupled to a securing device according to an embodiment.

FIG. 26 is a schematic view of the arresting strap of FIG. 22 coupled to a user's wrist.

FIG. 27 is a top view of the arresting strap of FIG. 22.

FIG. 28 is a schematic view of the arresting strap of FIG. 22 being worn on a user's wrist.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for secure containers or other cargo, such as a handbag or briefcase, during movement. In one example embodiment, a securing device may include one or more attachment straps for attaching to an object (e.g., a seat headrest) and one or more container straps for attaching to the container. In some embodiments, a securing device may be used to secure a handbag or other carrying case to a car seat while driving. Additionally, or alternatively, a securing device may be used to secure one or more containers, such as a handbag and a personal item, to a piece of rolling luggage. Securing a container during driving helps prevent such items from tipping over or falling on the floorboard of a vehicle while driving. Additionally, securing a container may help deter, minimize, or prevent distracted driving (e.g., prevents a driver from reaching for a fallen or falling bag, thus allowing a driver to maintain focus on driving, keeping both hands on the steering wheel and eyes on the road). Such a securing device may also reduce the likelihood that the handbag or other container is stolen. For example, a securing device may deter a container from being stolen from a vehicle, such as a convertible, or through an open window, when it is stopped. Example embodiments described herein may be adjustable in size to accommodate various sizes of handbags and carrying cases and allow multiple bags to be secured together. Additionally, or alternatively, a securing device may ensure that the contents of a container, such as take-out food, remains in an upright position.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of steps performed in the execution of a method does not imply that those steps must be performed in the order presented but instead may be performed in a different order or in parallel.

With reference to FIG. 1, an example embodiment of a securing device 1 is shown attached to a container, such as handbag 3, resting on a vehicle seat 2. The securing device 1 comprises a first pair of attachment straps 4 and a second pair of attachment straps 5 that each extend from a connector, such as a junction ring 8, at opposing angles to create a substantially Y-shaped configuration. The first pair of attachment straps 4 and the second pair of attachment straps 5 are configured to be releasably secured to headrest posts 10 on which a conventional headrest 9 is mounted. The first pair of attachment straps 4 and the second pair of attachment straps 5, respectively, may form upper loops 12A and 12B, which are configured to be secured around the headrest posts 10. The number and size of attachment straps may vary, for example, based on the intended application. Additionally or alternatively, the length of the attachment straps may be adjustable.

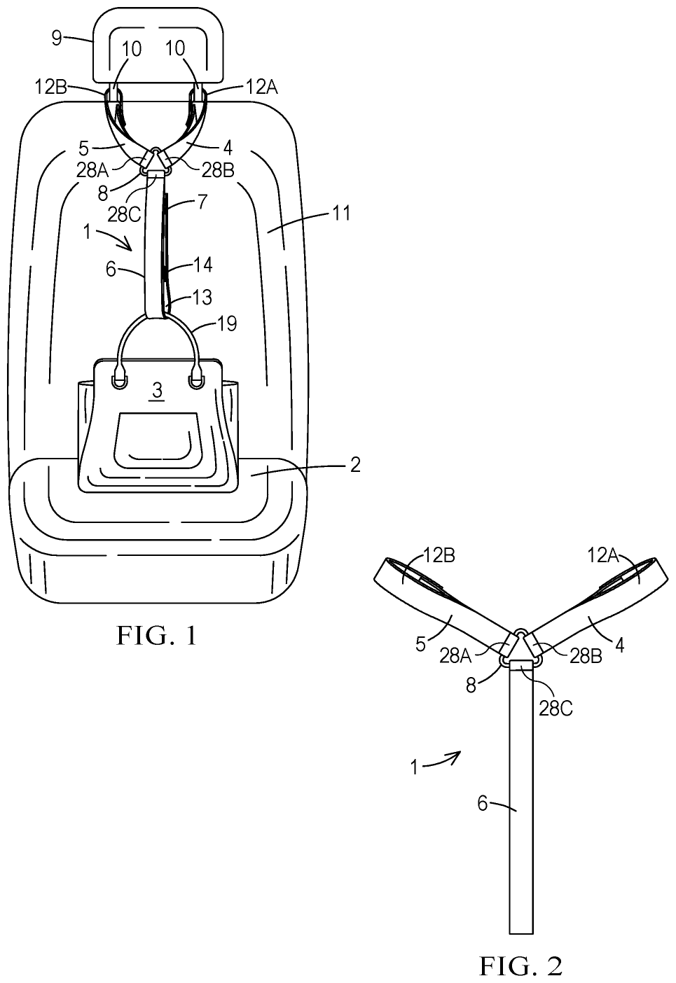

Still referring to FIG. 1, the securing device 1 includes a securing strap 6 coupled to and vertically hanging from the junction ring 8. Similarly, the securing strap 6 may form a lower loop 13, which is configured to be secured to a portion of the handbag 3 (e.g., around a handle 19). When positioned on a vehicle seat as shown in FIG. 1, the securing device 1 may hang forward in front of the seat backrest 11. It will be appreciated that a securing device can be used with any type of vehicle seat that accommodates the same. The number and size of the securing strap 6 may vary. Further, the length of the securing strap 6 may be adjustable. FIG. 2 shows pairs of attachment straps 4, 5 with upper loops 12A, 12B and the vertically-hanging securing strap 6 connected by the junction ring 8. One or more of the pairs of attachment straps 4, 5 and securing strap 6 may be removably coupled to the junction ring 8. For example, the pairs of attachment straps 4, 5 and securing strap 6 may include snaps allowing the pairs of attachment straps 4, 5 and securing strap 6 to be coupled to the junction ring 8. The junction ring 8 may be of any size or shape, such as circular, triangular, rectangular, etc. The junction ring 8 may be closed or able to be opened, for example, to extend through one or more of the pairs of attachment straps 4, 5 and securing strap 6 and then closed.

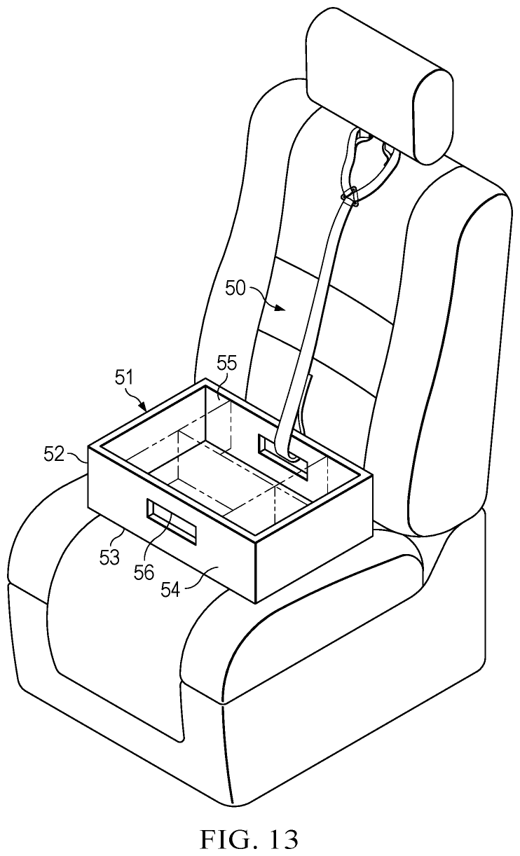

In an embodiment, more than one securing strap (e.g., 6) may be used to secure a relatively wide container. For example, a first securing strap may be secured to a first side of the wide container, and a second securing strap may be secured to a second side of the wide container. The securing strap (e.g., 6) may be coupled to a portion of the container other than a handle. In various embodiments, the securing strap (e.g., 6) may be threaded through slots in the container or looped through openings in a container (see, for example, FIG. 11).

In some embodiments, the pairs of attachment straps 4, 5 and securing strap 6 may be coupled without a connector. For example, the securing device 1 may be die-cut or laser-cut to form the pairs of attachment straps 4, 5 and securing strap 6. As another example, the pairs of attachment straps 4, 5 and securing strap 6 may be directly coupled (e.g., through stitching). The material for one or more of the pairs of attachment straps 4, 5 and securing strap 6 may be, without limitation, webbing (e.g., polypropylene), leather, faux leather, suede, faux suede, or a combination thereof.

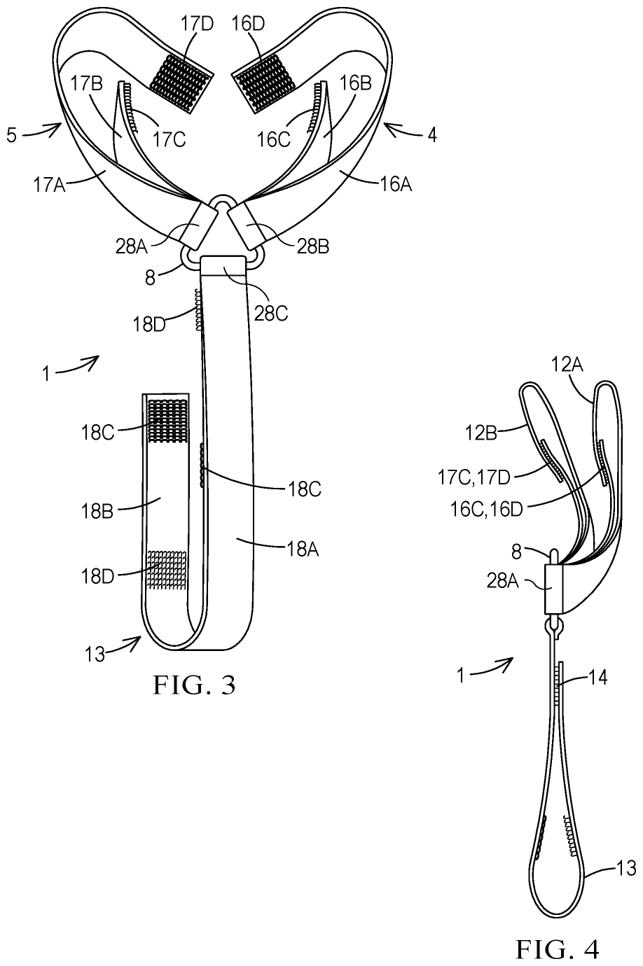

Referring to FIG. 3, in some embodiments, each of the pairs of attachment straps 4, 5 can include two portions—a long attachment strap 16A, 17A and a short attachment strap 16B, 17B, respectively. In some embodiments, the pairs of attachment straps 4, 5 may be made of a single strap instead of the long and short straps. Each of the attachment straps of the first and second pairs of attachment straps 4, 5 has one or more attachment points (e.g., complementary fasteners). Suitable fasteners can include, without limitation, hook-and-loop material (e.g., Velcro), snaps, hooks, carabiners, buckles, clasps (e.g., lobster claw clasps), or a combination thereof. It will be appreciated that in certain embodiments, the pairs of attachment straps 4, 5 and securing strap 6 can be free of notches, metal or cumbersome attachment points, such that the securing device 1 may remain secured to a vehicle seat without causing discomfort to a passenger. For example, in the illustrated embodiment, the securing device includes hook-and-loop fasteners 16C, 16D at the distal ends of the short and long attachment straps 16B, 16A, respectively, of the first pair of attachment straps 4 and hook-and-loop fasteners 17C, 17D at the distal ends of the short and long attachment straps 17B, 17A, respectively, of the second pair of attachment straps 5, such that the attachment straps (e.g., 16A, 16B, 17A, 17B) can be releasably securable to each other. In certain embodiments, each of the long attachment straps 16A, 17A and short attachment straps 16B, 17B can include an inner portion and outer portion. In such embodiments, the outer portion of each short attachment strap and the inner portion of each long attachment strap has an attachment point formed from the hook-and-loop fastening material (i.e., fasteners 16C, 16D, 17C, 17D), the attachment points being releasably securable to each other. The fasteners 16C, 16D, 17C, 17D enable the pairs of attachment straps 4, 5 to be securely fastened around the headrest posts 10 of the headrest 9.

Similarly, the securing strap 6 can have one or more attachment points. The securing strap can include two strap portions: an inner strap portion 18B and an outer strap portion 18A. In some embodiments, the inner strap portion 18B can have at least one piece of fastening material 18C, and the remainder of the securing strap 6 can have a plurality of corresponding fastening materials 18D, which allows the securing strap 6 to be adjustable in size to accommodate various sizes of hand bags, carrying cases, or other containers. It will be appreciated, however, that fasteners can be provided on either the inner or outer portions of a securing strap. For example, in embodiments where the fasteners are formed from a hook-and-loop fastening material, the fasteners can alternate between hook sections 18D and loop sections 18C along a length of the securing strap 6, such that the attachment points can be releasably securable to each other. The securing strap 6 may be configured to form more than one loop. The size and number fasteners on the pairs of attachment straps 4, 5 and securing strap 6 can vary. In one embodiment, the inner portion of the securing strap 6 can include four fasteners. Increasing the number of fasteners may allow for increased adjustability of the size of the pairs of attachment straps 4, 5 and securing strap 6. In certain embodiments, and as shown in FIG. 1, this adjustability can allow for the handbag 3, or other container or carrying case, to rest on the vehicle seat 11, such that it is not suspended by the lower loop 13 formed by the securing strap 6. Accordingly, the amount of stress placed on secured portions of the handbag 3 (e.g., handles 19) can be minimized, thereby reducing the possibility of breakage and/or spillage.

In various embodiments, one or more of the pairs of attachment straps 4, 5 and the securing strap 6 may have an open loop, non-use configuration (FIG. 3) and a closed, use configuration (FIG. 4). As shown in FIG. 3, in the open loop, non-use configuration, the hook-and-loop fasteners 16C, 16D, 17C, 17D of the attachment straps 4, 5 and the fastening materials 18C, 18D of the securing strap 6 are unattached. In such a configuration, the pairs of attachment straps 4, 5 and securing strap 6 may be positioned around a post 10 and/or handle 19 to be secured. As shown in FIG. 4, in the closed loop, use configuration, hook-and-loop fasteners 16C, 16D, hook-and-loop fasteners 17C, 17D are attached, respectively, and the fastening material 18C is attached to one of the fastening materials 18D at an attachment point 14. In other words, the upper loops 12A, 12B, and lower loop 13 are closed. Referring to FIG. 1, each of the upper loops 12A, 12B can surround a headrest post and the lower loop 13 can surround handles of a handbag, but it will be appreciated that upper and lower loops can be employed to surround other items (e.g., luggage handles).

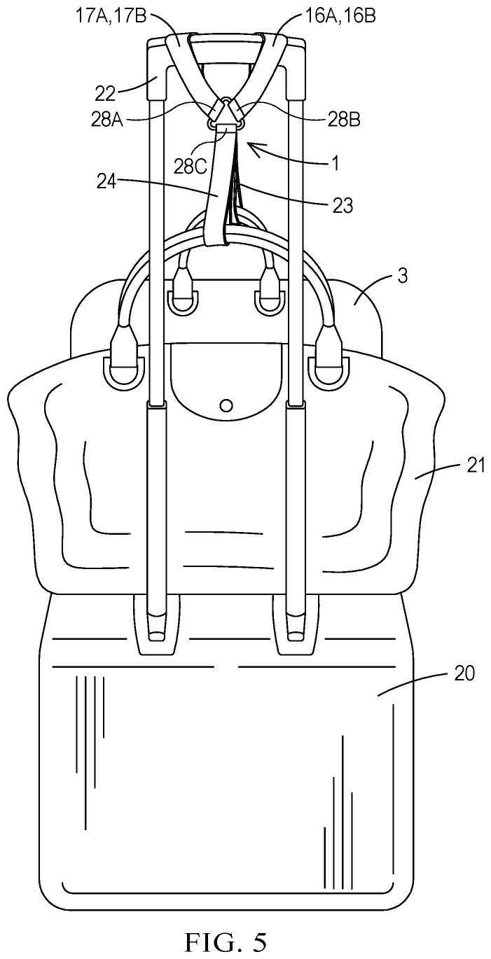

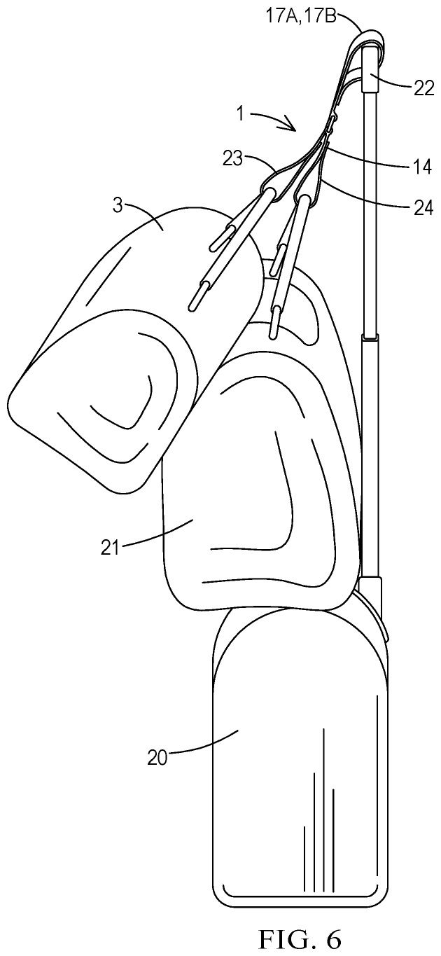

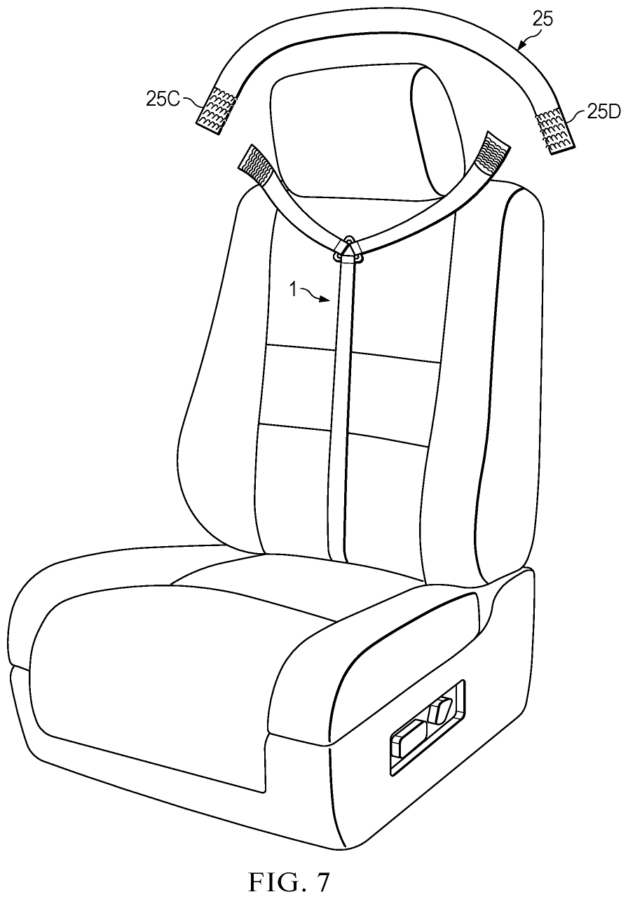

It will be recognized that the securing device may be used to secure a container to an object other than a car seat. With reference to FIGS. 5 and 6, in an embodiment, the securing device 1 is shown securing the handbag 3 and a personal item 21 to the handle 22 of carry-on luggage 20. The long attachment straps 16A, 17A and short attachment straps 16B, 17B are secured around the handle 22. In an embodiment, the securing strap 6 may be guided or looped through both the carrying handles of the handbag 3 and the personal item 21 to form two separate lower loops 23, 24, respectively. In other embodiments, the securing device 1 can include at least one additional securing strap 6 such that each item can be secured to the luggage 20 by an individual securing strap 6.

Referring to FIGS. 1-6, proximal ends of each of the long and short attachment straps 16A, 16B of the first pair of attachment straps 4 can be connected at a first upper junction 28A, and the first upper junction 28A can comprise a loop that completely surrounds an upper side of the triangular junction ring 8, or tri-ring. The long and short attachment straps 17A, 17B of the second pair of attachment straps 5 can be connected at a second upper junction 28B, and the second upper junction 28B can comprise a loop that completely surrounds another upper side of the triangular junction ring 8. Similarly, a proximal end of the securing strap 6 can be attached to the triangular junction ring 8 via a first lower junction 28C, and the first lower junction 28C can comprise a loop that completely surrounds a lower side of the triangular junction ring 8. The loops for each of the upper and lower junctions may be sized such that the first upper junction 28A is not slidable from the first upper side of the junction ring 8, the second upper junction 28B is not slidable from the second upper side of the junction ring 8, and the first lower junction 28C is not slidable from the first lower side of the junction ring 8. For example, such loops may provide a sufficiently snug fit and/or be of a sufficient width to prevent sliding. By preventing such sliding around the junction ring 8, improved stability of the securing device 1, and thus the carrying case (e.g., 3), can be provided. Movement of a handbag 3 or other carrying case relative to a vehicle seat 11 can exert a force on the junction ring 8 that, without the upper and lower junctions (i.e., 28A, 28B, 28C), could result in shifting of the attachment straps and/or securing straps, thereby affecting stability of the device 1. In some embodiments, one or more additional securing straps can extend from the first lower junction. In other embodiments, a proximal end of an additional securing strap can be attached to the triangular junction ring 8 via a second lower junction.

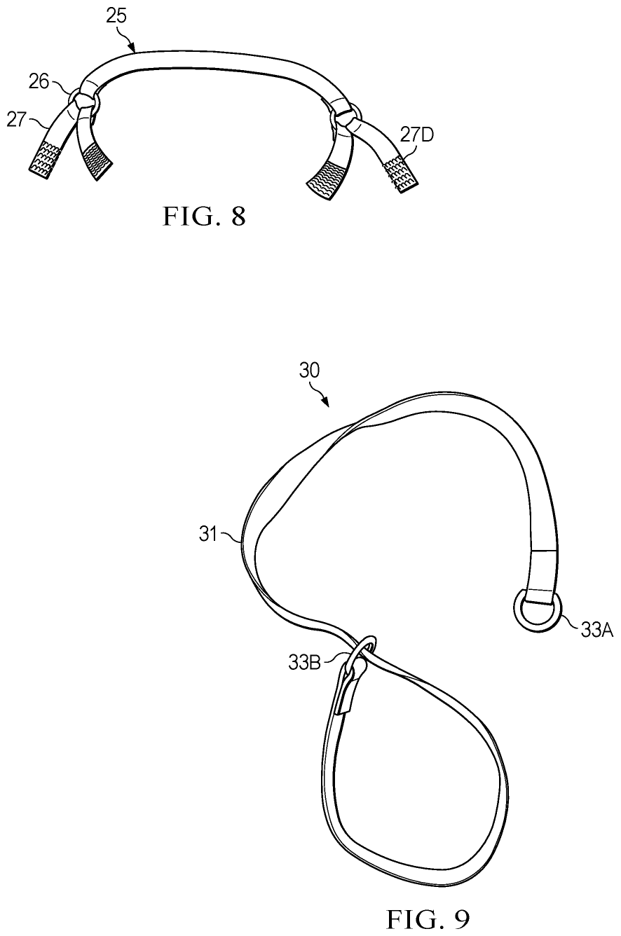

With reference to FIG. 7, in an embodiment, the securing device 1 may include an extension strap 25. The extension strap 25 may have fasteners, such as hook-and-loop fasteners 25C, 25D. For example, each of the hook-and-loop fasteners 25C, 25D may be positioned on an end of the extension strap 25. The extension strap 25 may be used for configurations where the attachment straps are not large enough to be secured to the desired object. For example, as shown in FIG. 7, a headrest 9 may not include conventional headrest posts 10. The extension strap 25 may be used to secure the attachment straps around the headrest 9. In an embodiment, the fasteners 25C, 25D of the extension strap 25 may be attached, respectively, to the fasteners of the attachment straps. In another embodiment, shown in FIG. 8, the extension strap may include connectors 26, such as O-rings or D-rings. Also coupled to the connectors 26 may be one or more additional straps 27 each including a fastener 27D. In one embodiment, the straps 27 may be coupled to the attachment straps (e.g., to the outer straps 16A, 17A and inner straps 16B, 17B).

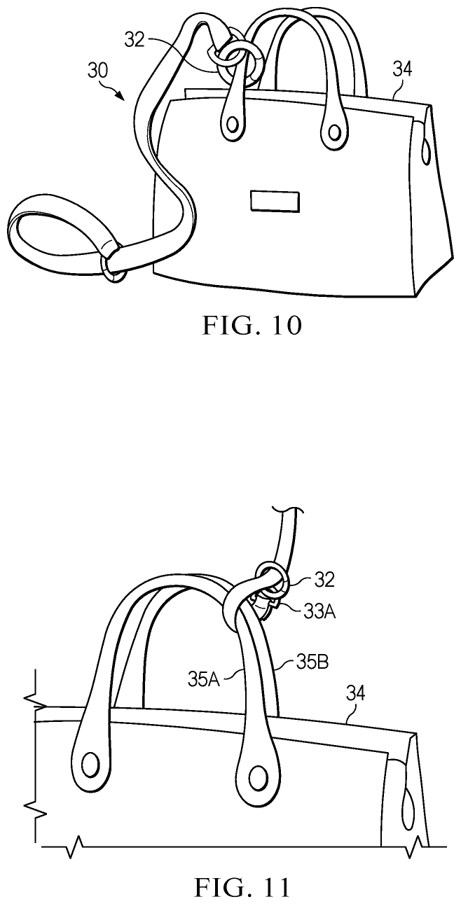

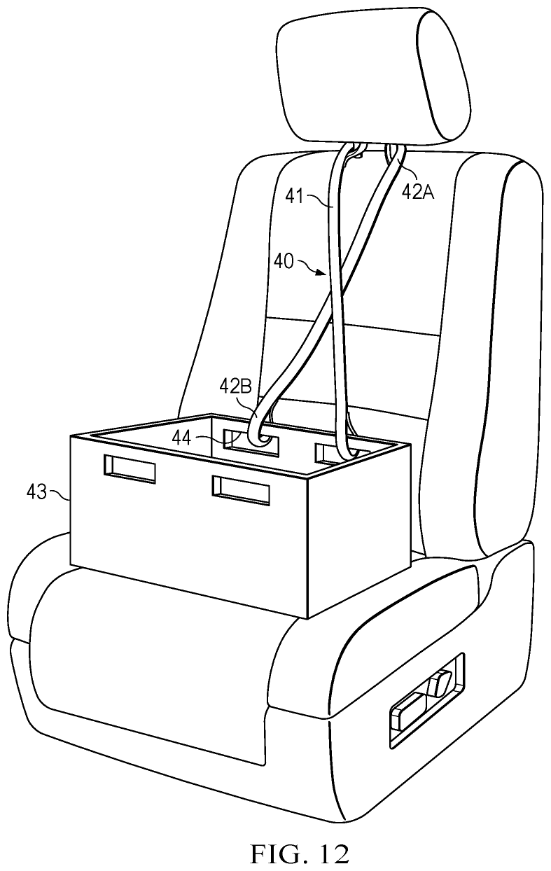

Referring now to FIGS. 9-11, according to an example embodiment, a securing device 30 includes a strap 31 selectively coupled to a connector ring 32. Strap 31 may include a fastener, such as D-rings 33A, 33B, at each end thereof. It will be recognized that suitable fasteners other than a D-ring, such as carabiners, may be used. In an embodiment, the connector ring 32 may be used in place of one of the D-rings 33A, 33B. The ends of the strap 31 may be permanently coupled (e.g., stitched) or removably coupled (e.g., using snaps or hook-and-loop material) to the D-rings 33A, 33B. The connector ring 32 may be secured to a container, such as a handbag 34 (FIG. 10). For example, the connector ring 32 may be secured around a handle 35A of the handbag 34 as shown in FIG. 11. The connector ring 32 may vary in size, for example, to fit the handles of different bags. The strap 31 may be coupled to the connector ring 32. In an embodiment, the D-ring 33A may be coupled to the connector ring 32, for example, with the connector ring 32 extending through the D-ring 33A. In some embodiments, the free end of the strap 31 may be looped around a second handle 35B of the handbag 34 and through the connector ring 32. In such a configuration, the two handles 35A, 35B are held together when the handbag 34 is secured. The free end of the strap 31 may then be secured to an object, such as a car seat or piece of luggage. The connection between the securing device 30 and the handbag 34, which uses D-rings or similar fasteners, may be stronger than a connection involving hook-and-loop material.

With reference to FIG. 12, according to an example embodiment, a securing device 40 includes two straps 41. The straps 41 are configured to be secured to headrest posts 10 on which a conventional headrest is mounted. The straps 41 may each form a loop 42A at a first end and a loop 42B at a second end. The loops 42A may be are configured to be secured around the headrest posts, and the loops 42B may be configured to be secured around a portion of a cargo container 43. The number and size of straps 41 may vary, for example, based on the intended application. Additionally or alternatively, the length of the straps 41 may be adjustable. To close the loops 42A, 42B, the straps 41 may include fasteners such as those described above. For example, the straps 41 may include a series of hook-and-loop fasteners that allow the loops 42A, 42B to be selectively opened and closed. The cargo container 43 may include openings 44 through which the loops 42B extend. Alternatively or additionally, the cargo container 43 may include handles or slots that are able to be coupled to the straps 41. In an embodiment, the straps 41 may be in a crisscross configuration to increase the stability of the cargo container during movement as shown in FIG. 12.

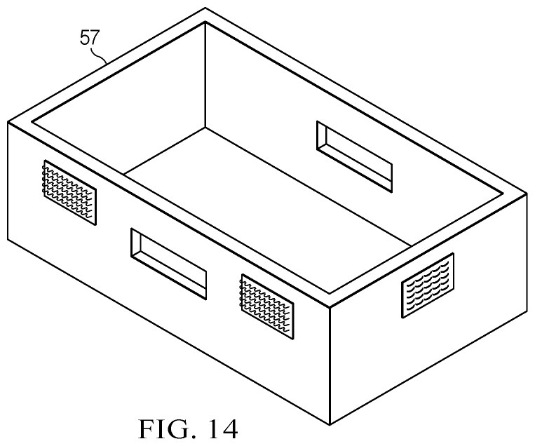

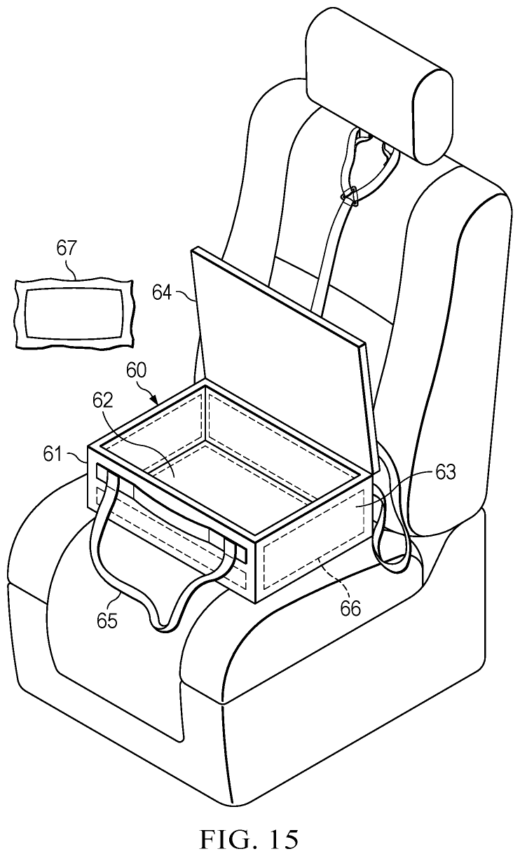

Referring to FIG. 13, according to an example embodiment, a securing device 50 may be coupled to a modular cargo container 51. The container 51 may include a container body 52 having a bottom 53 and side walls 54 extending upwardly therefrom. The bottom 53 and sidewalls 54 define an interior 55. One or more handles 56 may be positioned on an exterior of the side walls 54. In an embodiment, the container body 52 may include apertures or other features instead of or in addition to handles 56. The container 51 may be customizable. For example, referring to FIGS. 13 and 14, the container 51 may include one or more compartments 57 that are configured to be positioned in the interior 55 of the container body 52. The compartments 57 may be of different sizes, shapes, and materials. The compartments 57 may be selectively coupled to the container body 52 or each other. For example, the compartments 57 and optionally the container body 52 may include corresponding fasteners, such as hook-and-loop fasteners or magnets, which can help to secure the compartments 57 and their contents during movement of a vehicle. A user may arrange the compartments 57 in a desired configuration and securing the compartments 57 to each other and/or the container body 52.

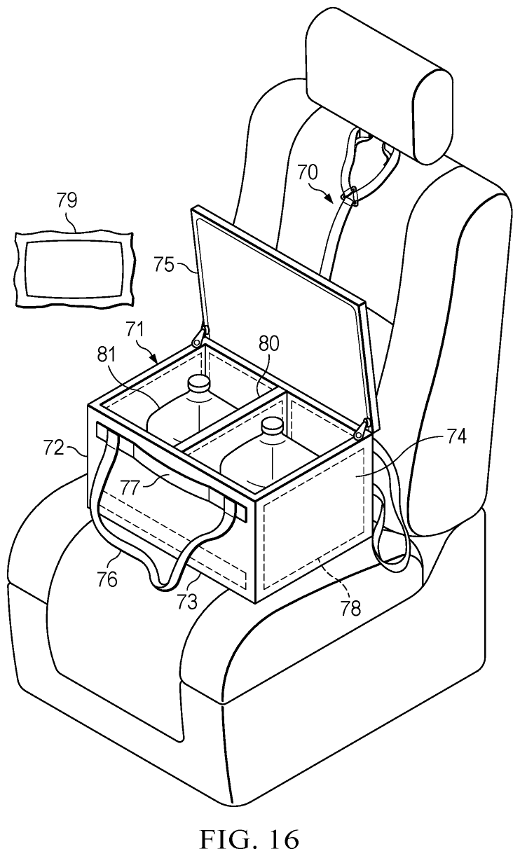

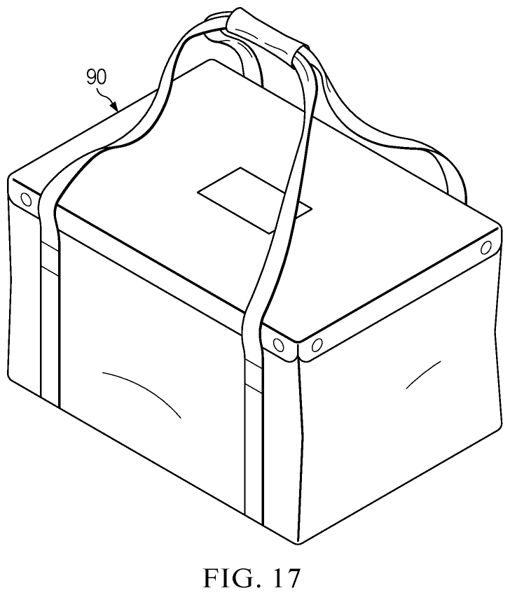

In various embodiments, a securing device may be used to secure an insulated container. For example, with reference to FIG. 15, an insulated container 60 may include a container body 61 including a bottom 62, sidewalls 63, a lid 64, and handles 65. The container body 61 may include pockets 66 or slots configured to receive removable thermal packs 67. As shown in FIG. 16, in another embodiment, a securing device 70 may be used to secure an insulated container 71. The insulated container 71 may include a container body 72 including a bottom 73, sidewalls 74, a lid 75, and handles 76. The lid may be closeable with, for example, a zipper or hook-and-loop fasteners. In addition to the handles 76, the container 71 may include a strap 77 that may be connected to the securing device 70. The container body 72 may include pockets 78 or slots configured to receive removable thermal packs 79. The container body may also include an interior wall 80, which may be configured to receive a thermal pack 79. The interior wall 80 may separate the contents. For example, the interior wall 80 may separate two liquid bottles 81. FIG. 17 shows another example container 90 that may be used.

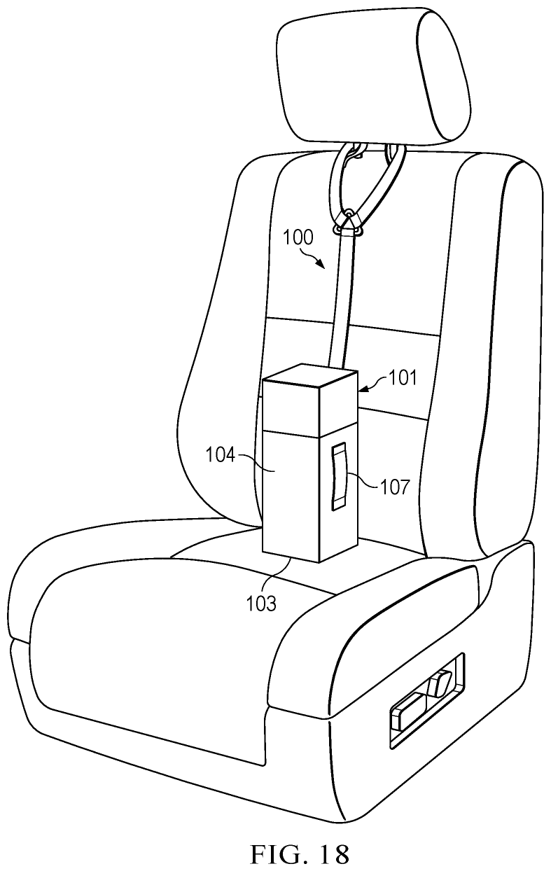

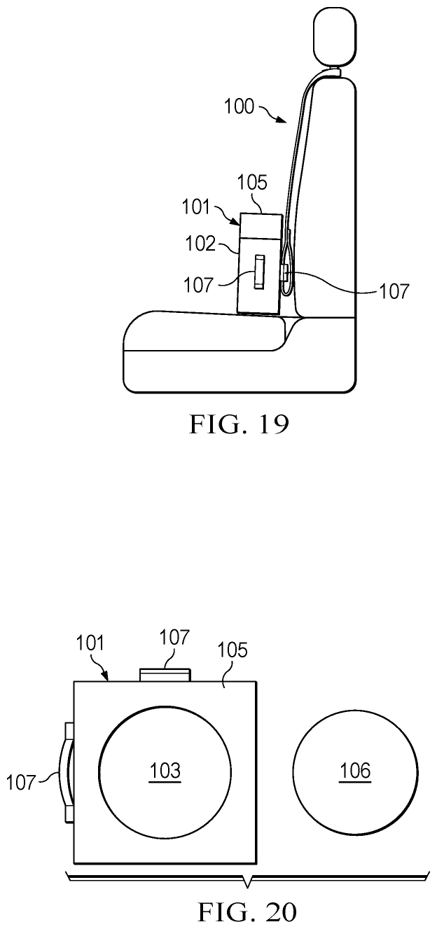

In some embodiments, a securing device may be used to secure a caddy. Referring to FIGS. 18-20, a securing device 100 can be coupled to a bottle caddy 101. The bottle caddy 101 may include a body 102 including a bottom 103 and sidewall 104 extending upward therefrom. The sidewall 104 may define an open top 105. A bottle may be inserted into the caddy 101 through the open top 105. A removable thermal pack 106, which can be shaped like a puck, may also be used in the caddy 101. The caddy 101 may be insulated, for example, with foam. The caddy 101 may have one or more handles 107 that allow the caddy 101 to be coupled to the securing device 100. In such an embodiment, the securing device 100 may keep the bottle in place and upright during movement of the vehicle.

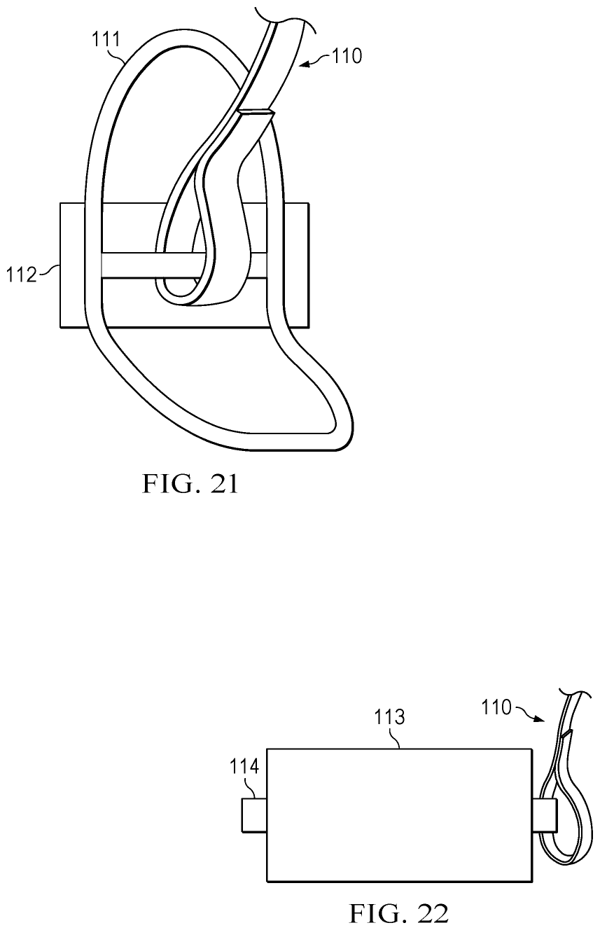

With reference to FIG. 21, in another embodiment, a securing device 110 may be used to secure a food caddy 111. For example, the food caddy 111 may be configured to extend around a food container, such as a pizza box 112. In another example, as shown in FIG. 22, the securing device 110 may be used to secure a caddy 113 with a handle 114.

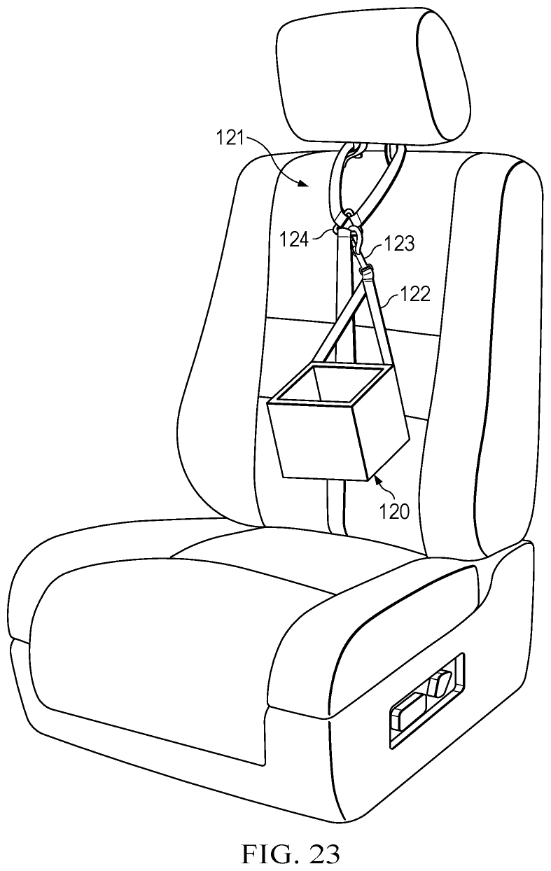

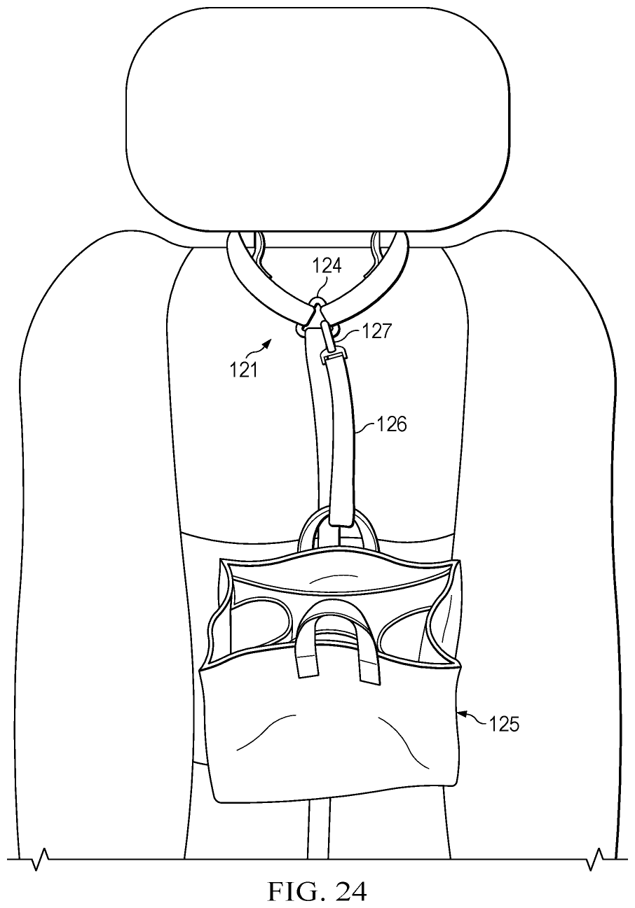

In various embodiments, a caddy or other container may be configured to hang from a securing device. With reference to FIG. 23, a caddy 120 may be hung from a securing device 121. The caddy 120 may include a handle 122 with a snap hook 123 for selective coupling to a junction ring 124. The caddy 120 may also be selectively hung to the device 121 using a carabiner, or other fastener. The caddy 120 can be made of, without limitation, a molded plastic, nylon, or other fabric. The size and shape of the caddy 120 may vary. For example, the caddy 120 may be configured to hold a cell phone, papers, or a bottle. In one embodiment, and as shown in FIG. 24, a caddy 125 having multiple compartments can be connected to the device 121 at the junction ring 124 via an additional securing strap 126 having a carabiner 127.

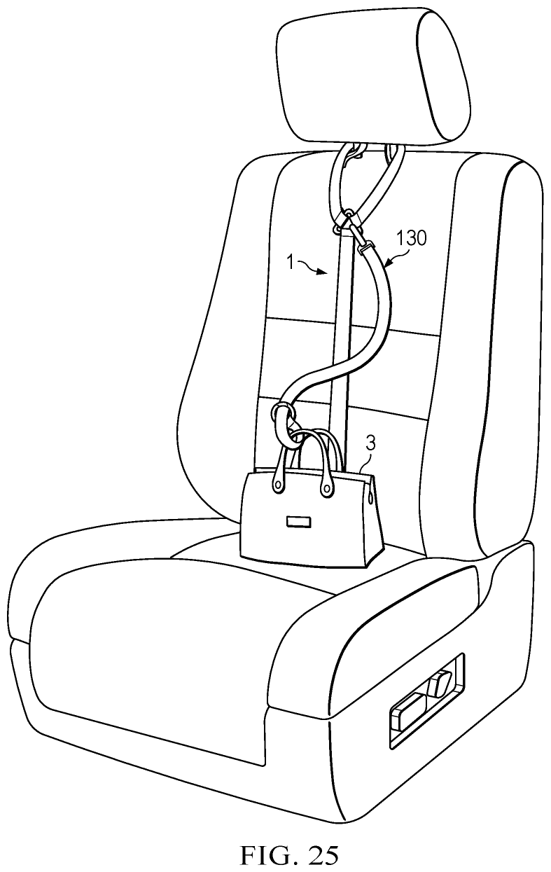

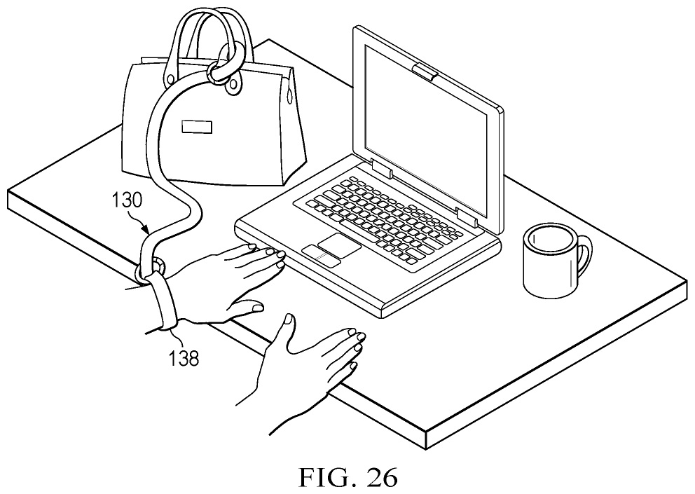

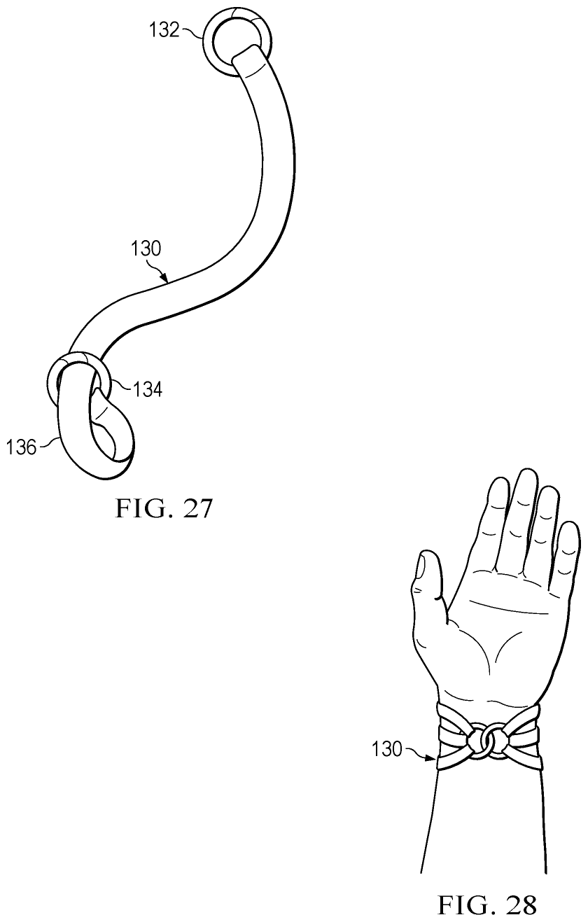

Example embodiments are also directed to an arresting strap for securing a container. With reference to FIGS. 25-28, in an embodiment, an arresting strap 130 includes a strap 131 extending between two connectors, such as carabiners 132, 134. Suitable connectors such as those discussed above may be used in addition or instead of carabiners. In FIG. 25, the arresting strap 130 is coupled to a securing device, such as securing device 1, and handbag 3. The carabiner 132 may be coupled to the junction ring 8 of the securing device 1. The arresting strap 130 may form a loop 136 (FIG. 27). The loop 136 may be configured to be secured to a portion of the handbag 3 (e.g., around a handle 19). The arresting strap 130 may be configured to form another loop 138. As shown in FIG. 26, a user may extend their hand through the loop 138 while the other end of the arresting strap 130 is coupled to the handbag 3. The arresting strap 130 may prevent theft of the handbag 3. When not in use securing a handbag, the arresting strap 130 may be worn by a user as a bracelet. The materials used in the arresting strap may vary. For example, the strap 131 may be made of fabric such as leather or webbing (e.g., polypropylene). The connectors may be decorative and may include, for example, inset crystals or other decorative stones. Additionally, the size of the strap or the connectors may vary.

While the above embodiments are directed to securing a handbag or personal item, the embodiments are not so limited. A securing device may also be used with other items, such as briefcases, camera cases, diaper bags, fragile packages, grocery bags, shopping bags, and so forth. Further, it will be appreciated that the securing device may be secured to objects other than a seat headrest or a piece of luggage.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A securing device for securing a carrying case having one or more handles to a vehicle seat, comprising:
a first pair of attachment straps and a second pair of attachment straps, each of the attachments straps having at least one attachment point at a distal end thereof; wherein the respective distal ends of the attachment straps for the first and second pairs are releasably securable via the attachment points to form a first upper loop surrounding a first headrest post and a second upper loop surrounding a second headrest post;
a mechanical junction ring connected at an upper end thereof to each of the first and second pairs of attachment straps; and
a vertically-hanging first securing strap attached at a proximal end thereof to the mechanical junction ring so as to create a substantially Y-shaped configuration with the attachment straps and having a first attachment point and a second attachment point, wherein the first securing strap is releasably securable to itself via the first and second attachment points to form a first lower loop surrounding the one or more handles.

2. The securing device of claim 1 wherein:
the at least one attachment point on each of the attachment straps is formed from a hook-and-loop fastening material.

3. The securing device of claim 2 wherein:
each of the first and second pairs of attachment straps comprises a long attachment strap and a short attachment strap;
each of the attachment straps comprises an inner portion and an outer portion; and
the outer portion of each short attachment strap and the inner portion of each long attachment strap has an attachment point formed from the hook-and-loop fastening material, the attachment points being releasably securable to each other.

4. The securing device of claim 1 wherein:
the first and second attachment points on the first securing strap are formed from a hook-and-loop fastening material.

5. The securing device of claim 4, wherein:
the first securing strap comprises an inner portion and an outer portion; and
the inner portion of the first securing strap has a plurality of the attachment points formed from a hook-and-loop fastening material.

6. The securing device of claim 5, wherein:
the plurality of the attachment points formed from a hook-and-loop fastening material alternates between hook sections and loop sections along a length of the first securing strap.

7. The securing device of claim 6, wherein:
the inner portion of the first securing strap has four attachment points.

8. The securing device of claim 1 wherein:
the mechanical junction ring has a triangular shape.

9. The securing device of claim 8 wherein:
each of the first and second pairs of attachment straps comprises a long attachment strap and a short attachment strap;
respective proximal ends of the long and short attachment straps of the first pair are connected at a first upper junction; and
respective proximal ends of the long and short attachment straps of the second pair are connected at a second upper junction.

10. The securing device of claim 9, wherein:
the first upper junction comprises a loop completely surrounding a first upper side of the triangular mechanical junction ring; and
the second upper junction comprises a loop completely surrounding a second upper side of the triangular mechanical junction ring.

11. The securing device of claim 10 wherein:
the first upper junction is not slidable from the first upper side of the triangular mechanical junction ring; and
the second upper junction is not slidable from the second upper side of the triangular mechanical junction ring.

12. The securing device of claim 8, wherein:
wherein the proximal end of the first securing strap is attached to the mechanical junction ring via a first lower junction.

13. The securing device of claim 12, wherein:
the first lower junction comprises a loop completely surrounding a lower side of the triangular mechanical junction ring.

14. The securing device of claim 13, wherein:
the first lower junction is not slidable from the lower side of the triangular mechanical junction ring.

15. The securing device of claim 12, further comprising:
a vertically-hanging second securing strap extending from the first lower junction and having a first attachment point and a second attachment point, wherein the second securing strap is releasably securable to itself via the first and second attachment points to form a second lower loop.

16. The securing device of claim 12, further comprising:
a vertically-hanging second securing strap attached at a second lower junction at a proximal end thereof to the mechanical junction ring at a lower end thereof so and having a first attachment point and a second attachment point, wherein the second securing strap is releasably securable to itself via the first and second attachment points to form a second lower loop.

17. The securing device of claim 1, wherein:
each of the attachment straps is free of notches or other metal attachment points.

18. The securing device of claim 1, wherein:
the securing strap is free of notches or other metal attachment points.

19. A method for securing a carrying device having one or more handles to a vehicle seat, comprising the steps of:
providing a securing device comprising:
a first pair of attachment straps and a second pair of attachment straps, each of the first and second pairs of attachment straps comprising a long attachment strap and a short attachment strap, and each of the attachments straps having at least one attachment point at a distal end thereof; wherein the respective distal ends of the attachment straps for the first and second pairs are releasably securable via the attachment points to form a first upper loop surrounding a first headrest post and a second upper loop surrounding a second headrest post;
a mechanical junction ring connected at an upper end thereof to each of the first and second pairs of attachment straps; and
a vertically-hanging first securing strap attached at a proximal end thereof to the mechanical junction ring so as to create a substantially Y-shaped configuration with the attachment straps and having a first attachment point and a second attachment point, wherein the first securing strap is releasably securable to itself via the first and second attachment points to form a first lower loop surrounding the one or more handles;
wrapping the long attachment strap of each of the first and second pairs around the respective first and second vehicle headrest posts;
securing the long attachment straps to the respective short attachment straps by connecting the attachment points to form the first upper loop surrounding the first headrest post and the second upper loop surrounding the second headrest post;
guiding the first securing strap around the one or more handles on the carrying device; and
connecting the first and second attachment points of the first securing strap to secure the carrying device to the vehicle seat.

20. A method for securing at least one carrying device having one or more handles to an extended handle of a luggage case, comprising the steps of:
providing a securing device comprising:
a first pair of attachment straps and a second pair of attachment straps, each of the first and second pairs of attachment straps comprises a long attachment strap and a short attachment strap, and each of the attachments straps having at least one attachment point at a distal end thereof; wherein the respective distal ends of the attachment straps for the first and second pairs are releasably securable via the attachment points to form a first upper loop surrounding a first portion of the extended handle and a second upper loop surrounding a second portion of the extended handle;
a mechanical junction ring connected at an upper end thereof to each of the first and second pairs of attachment straps; and
a vertically-hanging first securing strap attached at a proximal end thereof to the mechanical junction ring so as to create a substantially Y-shaped configuration with the attachment straps and having a first attachment point and a second attachment point, wherein the first securing strap is releasably securable to itself via the first and second attachment points to form a first lower loop surrounding the one or more handles;
wrapping the long attachment strap of each of the first and second pairs around the extended handle of the luggage;
securing the long attachment straps to the respective short attachment straps by connecting the respective attachment points to form the first upper loop surrounding the first portion of the extended handle and the second upper loop surrounding the second portion of the extended handle;
guiding the first securing strap around one or more handles on the carrying device; and
connecting the first and second attachment points of the first securing strap to secure the carrying device to the extended handle of the luggage.
